(19) United States
(12) Patent Application Publication
(10) Pub. No.: US 2004/0044463 A1
(43) Pub. Date: Mar. 4, 2004

(54) Surface surveillance system for an airport and method

(75) Inventors: Tai Shen-Feng, Hsinchu (TW); Tsen Yuh-Jou, Hsinchu (TW); Kang Wen-Jye, Hsinchu (TW); Lin Chin-E, Tainan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Industrial Technology Research Institute, Hsinchu (TW)

(21) Appl. No.: 10/234,892

(22) Filed: Sep. 4, 2002

(51) Int. Cl. G06G 7/76

(52) U.S. Cl. 701/120; 342/36

(57) ABSTRACT

The present invention provides a surface surveillance system for an airport. The system includes a controlled device including a first data, and a controlling device including a second data. The controlling device receives the first data of the controlled device and controls the controlled device by means of sending the second data in responds to the first data to the controlled device, thereby the airport being under surveillance by the system.

### FIELD OF THE INVENTION

The present invention is related to a surface surveillance system and a method thereof, and more particularly, to a surface surveillance system for use in an airport of being surveilled and a surveillance method thereof.

### BACKGROUND OF THE INVENTION

Conventional surface surveillance system and method for an airport is using the search radars to collect the information of the aircrafts, such as the altitudes, distances, heading directions and positions of them. And assisted by the oral reportage from pilots and then integrated those information in the air traffic managing center to result in some judgments to inform each aircraft and the units on the airport surface for taking some appropriate actions. The conventional system and method can normally work. But the quantity and speed of aircraft increasingly and let the oral reports seem slow and inaccurately; and the searching radar is easily affected by geography and weather, so it has some weaknesses in practice.

Therefore, base on the current establishment, the CNS/ATM (Communication, Navigation and Surveillance, Automatic Traffic Management) system is been built. In communication, the data communicating chain is introduced to complement the lack of the oral communication and reinforce the transmission and exchange of data. In navigation, the conventional ground guiding by the GPS and INS is replaced for achieving the object of free flight. In surveillance, the surveillance of the aircraft is reinforced by means of automatic feed back report. The current flight surveillance system provides the distances, directions and identity by means of searching and pursuing aircrafts in a limited airspace via the primary search radar (PSR), secondary search radar (SSR), and accompanied by the oral report from the pilot for controlling the airspace. However, the radars cannot sufficiently detect and surveille the staff, vehicles and blocks on the airport surface. Thus, radars is hard to be built broadly because of the high establishment cost.

Another conventional surveillance system called as automatic dependent surveillance broadcast (ADS-B) can receive the position data of the aircrafts via the navigation satellites (GPS or GLONASS), and then broadcast the position data of the aircrafts through the bi-direction chain of the avionics navigating system by the way of real time and omnibearing. It also can receive the related position data broadcasted from other aircrafts and from the ground receiving/managing stations, and show them both on the displays of those aircrafts and the stations to reveal the relative positions between all aircrafts for avoiding aerial closing and crash. So the air traffic surveillance/control is more sufficient than the earlier system.

Therefore, the ADS-B system is provided for secluding and protection in air-to-air mode and air-to-ground mode by bi-direction broadcast. It can surveille the aircraft during taking off/landing, taxiing and down/up loading passenger/merchandise, and the vehicle, staff and any restrict area on the airport surface.

However, the broadcast data are transmitted through the satellites so it must cost a lot. Further more, the wireless modem has many limitations on frequency, transmission distance and other performances, and there's some problems on the capability for the ground devices to match the ADS-B system. Therefore, a modern airport needs a surface surveillance system, which has a high stability and won't be limited by the distance and frequency, to assist current surveillance system, thus the objects of overall surveillance and high efficiency can be achieved.

### SUMMARY OF THE INVENTION

It is an object of the present invention to provide a surface surveillance system and method for an airport to collect and coordinate the data built in the aircrafts in an airspace, for sufficiently surveille to an airport surface.

It is another object of the present invention to provide a surface surveillance system and method for an airport to collect and coordinate the data built in the movable object on an airport surface, for sufficiently surveille to an airport surface.

It is another object of the present invention to provide a surface surveillance system and method for an airport to collect and coordinate the data built in the fixed object on an airport surface, for sufficiently surveille to an airport surface.

According to the preferred embodiment of the present invention, a surface surveillance system for an airport, includes a controlled device including a first data and a controlling device including a second data for receiving the first data of the controlled device and controlling the controlled device by means of sending the second data in responds to the first data to the controlled device, thereby the airport being under surveillance by the system.

Preferably, the first data has a parameter of the controlled device.

Preferably, the second data has a command for controlling the controlled device.

Preferably, the controlling device and the controlled device have a communication therebetween.

Certainly, the controlling device can be an air traffic managing center.

Certainly, the controlled device can be a fixed object selected from a group consisting of a block, a construction zone, a restricted zone, an isolation zone, and a dangerous zone.

Certainly, the controlled device can be a movable object selected from a group consisting of an airplane, a person, and a vehicle.

Preferably, the communication between the controlled and the controlling devices can be transferred through a mobile communication provider.

Preferably, the mobile communication provider further includes a communication network further including a database having an aviation information communicated through a firewall.

Preferably, the firewall can be built between the database and a network separated from the communication network.

Preferably, the mobile communication provider further includes a module selected from the group consisting of a global system for mobile communication (GSM), a general packet radio service (GPRS) and a personal handyphone system (PHS).

Preferably, the first data can be a GPS message.

Preferably, the controlled device further includes a processor for processing the second data sent from the controlling device; and a monitor for displaying the second data; and the controlling device further comprises a managing device for processing the first data transmitted from the controlled device, and then showing the first data on the managing device, in which the controlled and the controlling devices act with a geography information system (GIS).

Accordingly, the present invention further includes an automatic dependent surveillance broadcast (ADS-B) device connected with the controlled and the controlling devices wherein at least one airplane transmits a position data thereof through the ADS-B to the controlled and the controlling devices.

Accordingly, the communication between the controlled and the controlling devices can be communicated through one of an intranet and an internet.

Accordingly, the controlling device further includes a database having an aviation information communicated with the internet through a firewall built between the database and the internet.

Accordingly, the parameter can be selected from a group consisting of a speed, a direction, an alert coverage, a location, a dimension and an code.

Accordingly, the second data indicates a moving direction to the controlled device, and includes the first data sent from another the respective controlled device.

Accordingly, the present invention further includes plural controlled devices wherein the plural controlled devices communicate with each other directly and are free of communicating through the controlling device.

According to another aspect of the present invention, an airport surface surveillance method, includes steps: (a) providing a first data for a controlled device, (b) transmitting the first data to a controlling device, (c) transforming the first data into a second data, (d) transmitting the second data to the controlled device; and (e) causing the controlled device to respond according to the second data.

Preferably, the first data has a parameter of the controlled device.

Preferably, the second data has a command for controlling the controlled device.

Preferably, the controlling device and the controlled device have a communication therebetween.

Preferably, the controlling device can be a air traffic manage center.

Preferably, the controlled device can be a fixed object selected from a group consisting of a block, a construction zone, a restricted zone, an isolation zone, and a dangerous zone.

Preferably, the controlled device can be a movable object selected from a group consisting of an airplane, a person, and a vehicle.

Preferably, the communication between the controlled and the controlling devices can be transferred through a mobile communication system built by a mobile communication provider.

Preferably, the mobile communication provider further includes a module selected from the group consisting of a global system for mobile communication (GSM), a general packet radio service (GPRS) and a personal handyphone system (PHS).

The foregoing and other features and advantages of the present invention will be more clearly understood through the following descriptions with reference to the drawings, wherein:

### BRIEF DESCRIPTION OF THE DRAWINGS

FIG. 1 is a schematic view showing the embodiment of the present invention;

FIG. 2 is a schematic view of the controlled device of the present invention;

FIG. 3 is a schematic view of the controlling device of the present invention;

FIG. 4 is a simulate electrical map of an airport surface;

FIGS. 5 to 8 are the schematic views showing the warning status of the present invention;

FIG. 9 is a schematic views showing the integrated combination of the present invention and current airport surface detection system;

FIG. 10 is an architecture of a high security mobile communication system of the present invention; and

FIG. 11 is a schematic view of the system and method of the present invention.

### DETAILED DESCRIPTION OF THE PREFERRED EMBODIMENT

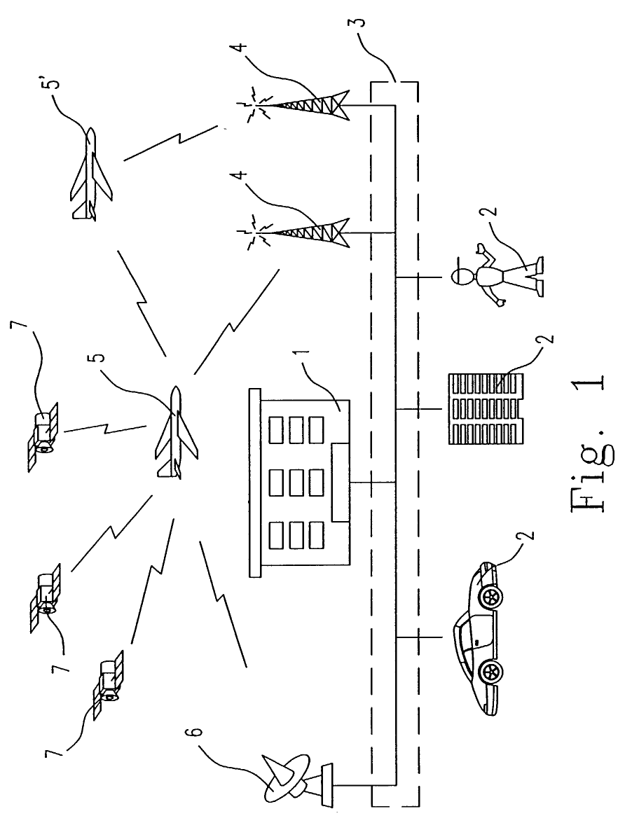

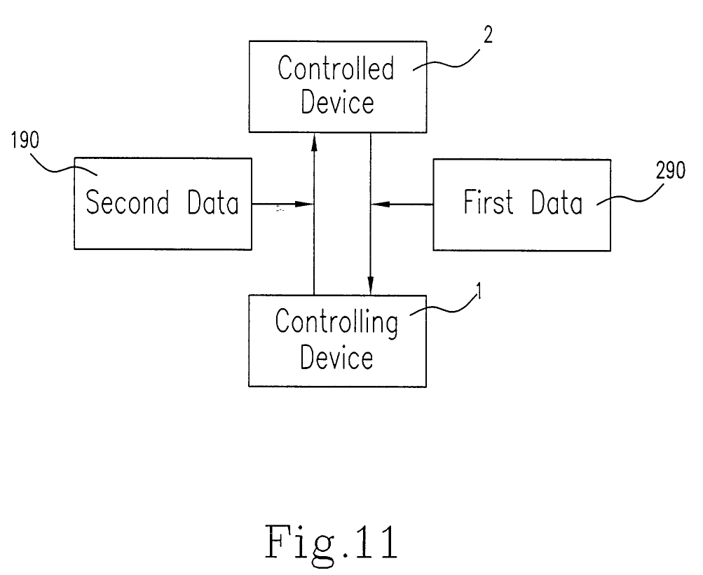

Please refer to FIG. 11, the present invention is a surface surveillance system for an airport, includes a controlled device 2 which including a first data 290 for providing a parameter of the controlled device 2; and a controlling device 1 including a second data 190 for providing a command. Further, the controlled device 2 transmits the first data 290 to the controlling device 1, and the controlling device 1 transmit the second data 190 to the controlled device 2, to make the controlling device 1 can certainly handle the parameter of the controlled device 2, through the data communications between the controlled device 2 and the controlling device 1. And then a command is provided by the second data 190 to the controlled device 2 so the airport surface surveillance is achieved. Please further refer to the FIG. 1, the first data 290 and the second data 190 can be transmitted by a network 3.

Please refer to FIG. 11, the present invention is also a surface suveillance method for an airport, includes the following steps of: providing a controlled device 2 has a first data 290 thereof, transmitting the first data 290 to a controlling device 1, transforming the first data 290 into a second data 190 by the controlling device 1, and transmitting the second data 190 to the controlled device 2. After all, the controlled device 2 is controlled in response to the second data 190.

Please refer to the FIG. 1, is a schematic view showing the embodiment of the present invention. The controlled devices 2 are the movable and fixed objects on the airport surface. The movable objects mainly include many kinds of vehicles, such as luggage van, transporting car, engineer car, artic, fire engine, and fuel tanker, and so on. They further include the staff of airport and aircrafts, porters, engineers and temporary staffs. The fixed objects mainly include the blocks and warning signs and the area they represent, such as construction zone, a restricted zone, an isolation zone, and a dangerous zone.

The controlled device 2 communicate with the controlling device 2, ADS-B devices 4 and radar 6 by means of transmitting the first and second data 290 and 190 to each other through the network 3. The aircrafts 5, 5′ receive its own position data and transfer them to the ADS-B device 4 for being broadcasted to broader the transfer area. The aircrafts 5 and 5′ can also exchange information with each other. The controlling device 1 can be the air traffic manage center.

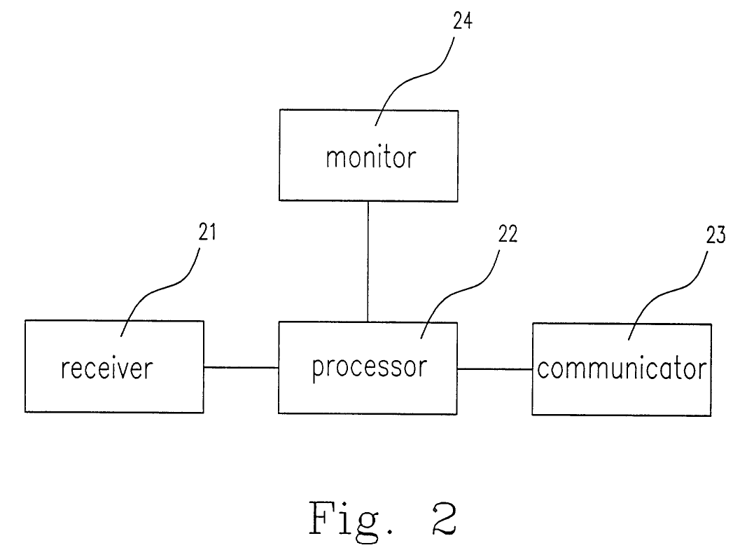

Please refer to the FIG. 2, the controlled device 2 is constructed by a receiver 21, a processor 22, a communicator 23 and a monitor 24. The receiver 21 is for receiving position data. The processor 22 is for integrating the position data and the GIS for showing them on the monitor 24. And then the controlled device 2 send its own position data back to the controlling device 1 through the communicator 23 (shown in FIG. 1).

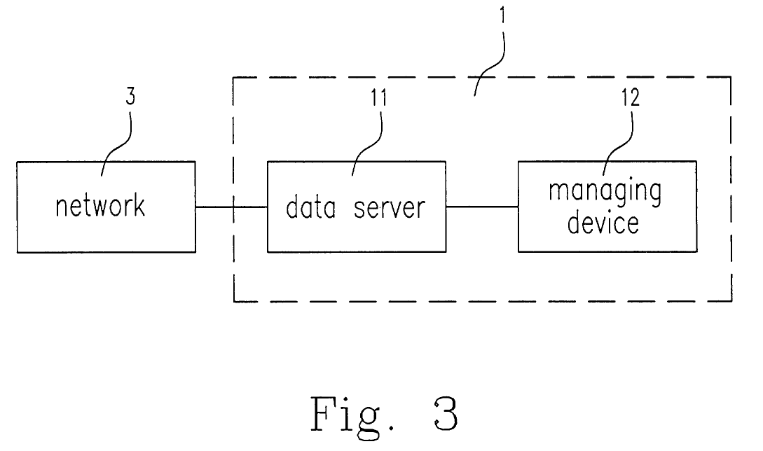

Please refer to the FIG. 3, the controlling device 1 has a data server 11 for getting a data from network 3 and then transmitting the data to the managing device 12.

Please refer to the FIGS. 1, 2 and 3, the controlled device 2 is managed by the controlling device 1. The controlling device 1 transmit the data to the data server 11 via the network 3, and then transmits it to the managing device 12. The receiver 21 of the controlled device 2 has a capability of receiving GPS information. The communicator 23 is a hardware or mobile phone within a GSM/GPRS module. The GPS information received by the receiver 21 can be transferred to the processor 22. The processor 22 cooperates the GPS information with GIS, and then show it on the monitor 24. And the controlled device 2 uses the communicator 23 to send the position data thereof to the controlling device 1.

While an aircraft 5 takes off or lands, the position data of the aircraft 5 is transmitted from the satellite 7 to the aircraft 5 via the ADS-B device 4 and is broadcasted through a bi-direction wireless communication chain in an omnibearing and real time mode. At the same time, the ADS-B device 4 also receives the broadcasting of the other aircraft 5′ and the other air traffic managing center (not shown in the Figs.). Further, the ADS-B device 4 inform the related information about the aircraft 5 (5′), and controlled devices 2 (staff, vehicles, and blocks) of one airspace to the pilots on the aircraft 5 (5′), and inform to the staffs in controlling device 1 (air traffic managing center) via the network 3. Also the controlled devices 2 are noticed the information of the aircraft 5 (5′) through the network 3. By the combination of the present invention and conventional ADS-B device 4, the surveillance for an airport surface become perfect.

For the accuracy of the position data, the GPS difference correcting station can be built in airport, for correcting the GPS information immediately.

The dynamic information of aircraft 5 is executed by the aircraft communication addressing and reporting system (ACARS) thereof.

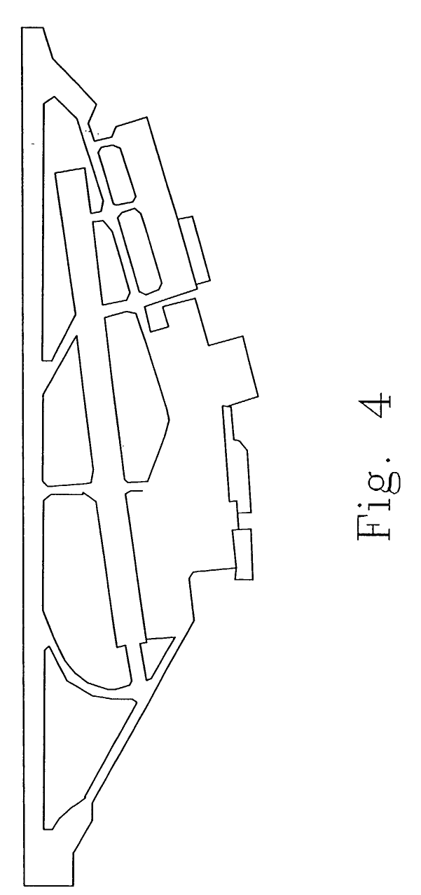

Please refer to the FIG. 4, it illustrates a simulate electrical map of an airport surface. The map is a kind of the GIS information for simulating a plan view of an airport surface. Accompanying the electrical map with the position data, the controlled device 2 in the FIG. 1 can realize the position thereof, and the positions of the other controlled devices 2 and aircraft 5.

For actually achieving the warning effect of the present invention, the monitor 24 of the controlled device 2 and the managing device 12 of the controlling device 1 can locally zoom in the display area.

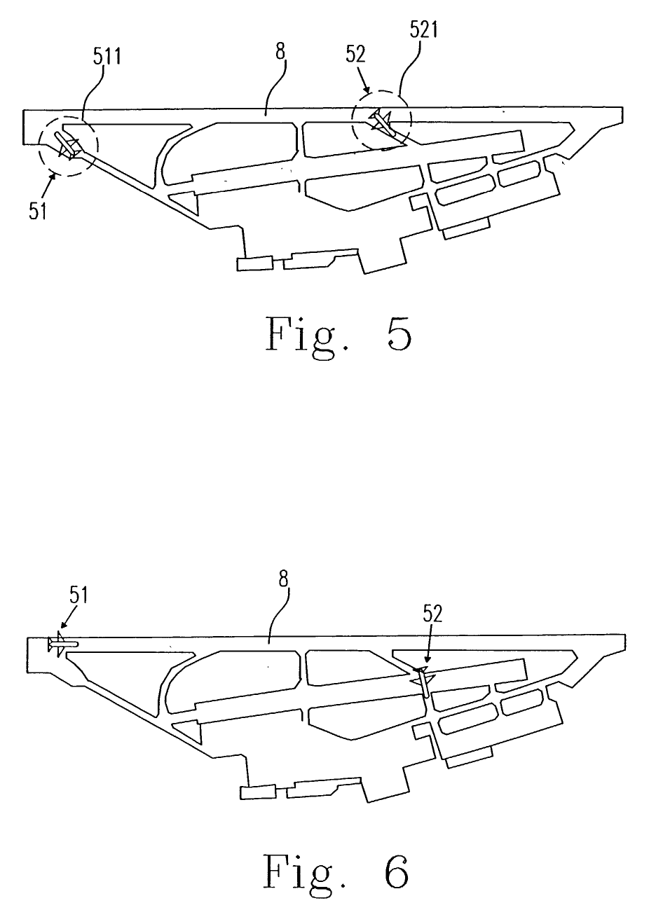

Please refer to the FIGS. 5 to 8, they are the schematic views showing the warning procedure of the present invention. Each of the figure shows the picture of the monitor 24 and the managing device 12 during the warning situations.

According to the FIG. 5, it is a schematic view showing the warning situation. According to the professional knowledge and practical experiences, set the warning circle 511 of the aircraft 51 and the warning circle 521 of the aircraft 52 are set base on the dimensions and speed of the aircrafts 5 (5′), staffs, vehicles and blocks (not shown in the figure). The aircrafts, staffs, vehicles, and blocks can be managed in any time by means of integrating via the controlling device 1 (FIG. 1), and the controlling device 1 (FIG. 1) can transmit a second data messages, commands) to them. For example, it is possible that the aircraft 51 entering to the runway 8 may collide with the aircraft 52 on the runway 8. So, the monitor 24 and the managing device 12 will display as the FIG. 5.

According to the FIG. 6, while the aircraft 52 leave from the runway 8, the warning state can be relieved.

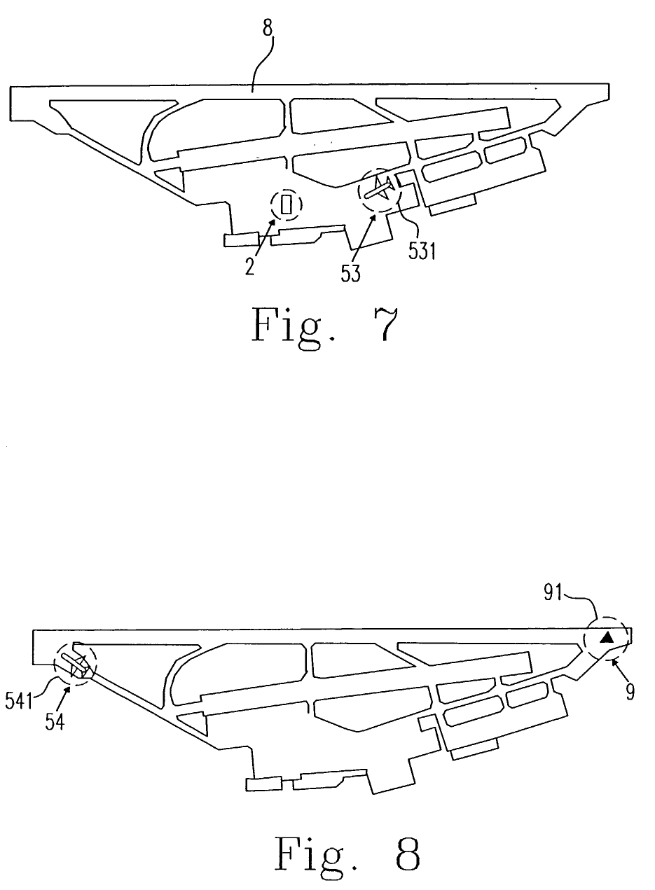

According to the FIG. 7, while there is a controlled device 2, like the staff, vehicle appears near the aircraft 53, the warning circle 201 and 531 will alarm on the monitor 24 and managing device 12.

According to the FIG. 8, while there is a block 9 (belong to the controlled device) on the runway 8, and an aircraft 54 is entering into the runway 8, the warning circle 91 of the block 9 and the warning circle 541 of the aircraft 54 will alarm.

Please return to the FIG. 1, the network 3 can be an internet or an intranet, even a communication network of a mobile communication provider. In the present time, for avoiding the waste of the repetition of investing communication network, the communication between the controlled device 2 and the controlling device 1 can be provided by the current mobile communication provider, and the resources of communication can be used fully. The mobile communication provider can have a module selected from the group consisting of a global system of mobile communication (GSM), a general packet radio service (GPRS) and a personal handyphone system (PHS).

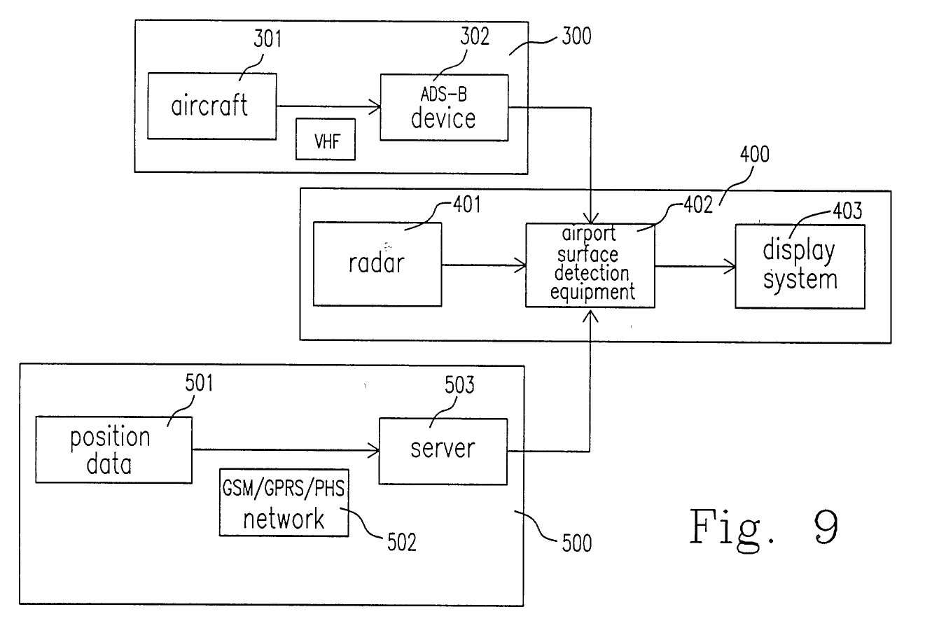

Please refer to the FIG. 9, it shows the integrated combination of the present invention and current airport surface detection system. The conventional air data chain 300 includes an aircraft 301 for sending a position information thereof to the ADS-B device 302 via the VHF radio. And a conventional ground data chain 400 includes a radar 401 for transmitting the information searched thereby to the airport surface detection equipment (ASDE) 402, and then the information is shown on a display system 403. According to the present invention, an airport surface surveillance system 500 has a controlled device 501 for transmitting the information thereof to the server 503 through the GSM/GPRS/PHS network 502, and then transmitting the information to the ASDE 402. Meanwhile, the controlled device 501 is selected from a group consisting of a person, a vehicle and blocks. So the surveillance for an airport can be done more faultless than before.

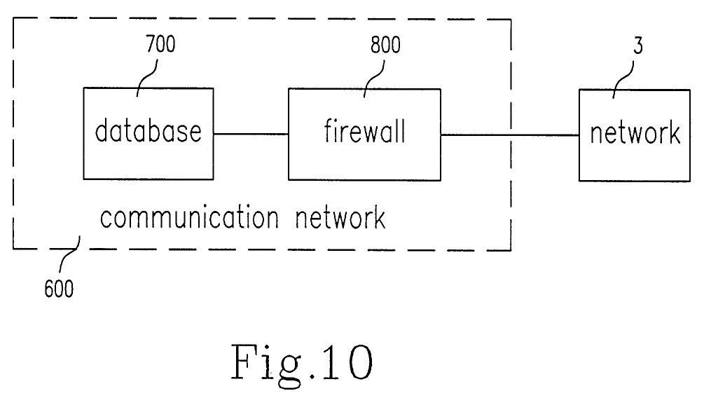

Please refer to the FIG. 10, it illustrates an architecture of a high security mobile communication system of the present invention. A mobile communication provider's communication network 600 itself is conventional, but the database 700 having a aviation information, and a firewall 800 are built in the communication network 600. Furthermore, the communication between the database 700 and internet 3 must through the firewall 800 so the security is higher than the conventional database (not shown in the FIG. 10) because of the conventional database built between the firewall and internet 3.

In conclusion of a simply way, please refer to the FIG. 11 the present invention installs a communication device on a vehicle, staff or a block of the airport surface. The communication device and the air traffic managing center can communicate to each other. The controlling device 1 can confirm the information of the location, speed of the vehicles, staff and blocks, and show the information on the controlling device 1. And the controlling device 1 sends a second data 190, such as many kinds of real time information and commands, to let the controlled device 2 taking reactions to avoid any accidents. So, the object of the present invention to provide a effective surface surveillance system and method for an airport can be achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A surface surveillance system for an airport, comprising:
a controlled device including a first data; and
a controlling device including a second data for receiving said first data of said controlled device and controlling said controlled device by means of sending said second data in responds to said first data to said controlled device, thereby said airport being under surveillance by said system.

2. The system according to claim 1, wherein said first data having a parameter of said controlled device.

3. The system according to claim 1, wherein said second data having a command for controlling said controlled device.

4. The system according to claim 1, wherein said controlling device and said controlled device have a communication therebetween.

5. The system according to claim 1, wherein said controlling device is an air traffic managing center.

6. The system according to claim 1, wherein said controlled device is a fixed object selected from a group consisting of a block, a construction zone, a restricted zone, an isolation zone, and a dangerous zone.

7. The system according to claim 1, wherein said controlled device is a movable object selected from a group consisting of an airplane, a person, and a vehicle.

8. The system according to claim 4, wherein said communication between said controlled and said controlling devices is transferred through a mobile communication provider.

9. The system according to claim 8, wherein said mobile communication provider further comprises a communication network further comprising a database having an aviation information communicated through a firewall.

10. The system according to claim 9, wherein said firewall is built between said database and a network separated from said communication network.

11. The system according to claim 8, wherein said mobile communication provider further comprises a module selected from the group consisting of a global system for mobile communication (GSM), a general packet radio service (GPRS) and a personal handyphone system (PHS).

12. The system according to claim 1, wherein said first data is a GPS message.

13. The system according to claim 1, wherein said controlled device further comprises:
a processor for processing said second data sent from said controlling device; and
a monitor for displaying said second data; and said controlling device further comprises:
2 managing device for processing said first data transmitted from said controlled device, and then showing said first data on said managing device,
wherein said controlled and said controlling devices act with a geography information system (GIS).

14. The system according to claim 1 further comprising an automatic dependent surveillance broadcast (ADS-B) device connected with said controlled and said controlling devices wherein at least one airplane transmits a position data thereof through said ADS-B to said controlled and said controlling devices.

15. The system according to claim 4, wherein said communication between said controlled and said controlling devices is communicated through one of an intranet and an internet.

16. The system according to claim 15, wherein said controlling device further comprises a database having an aviation information communicated with said internet through a firewall built between said database and said internet.

17. The system according to claim 1, wherein said parameter is selected from a group consisting of a speed, a direction, an alert coverage, a location, a dimension and an code.

18. The system according to claim 1, wherein said second data indicates a moving direction to said controlled device, and includes said first data sent from another said respective controlled device.

19. The system according to claim 1 further comprising plural controlled devices wherein said plural controlled devices communicate with each other directly and are free of communicating through said controlling device.

20. An airport surface surveillance method, comprises steps:
providing a first data for a controlled device,
transmitting said first data to a controlling device,
transforming said first data into a second data,
transmitting said second data to said controlled device; and
causing said controlled device to respond according to said second data.

21. The method according to claim 1, wherein said first data having a parameter of said controlled device.

22. The method according to claim 1, wherein said second data having a command for controlling said controlled device.

23. The method according to claim 1, wherein said controlling device and said controlled device have a communication therebetween.

24. The method according to claim 20, wherein said controlling device is a air traffic manage center.

25. The method according to claim 20, wherein said controlled device is a fixed object selected from a group consisting of a block, a construction zone, a restricted zone, an isolation zone, and a dangerous zone.

26. The method according to claim 20, wherein said controlled device is a movable object selected from a group consisting of an airplane, a person, and a vehicle.

27. The method according to claim 20, wherein said communication between said controlled and said controlling devices is transferred through a mobile communication provider.

28. The method according to claim 27, wherein said mobile communication provider further comprises a module selected from the group consisting of a global system for mobile communication (GSM), a general packet radio service (GPRS) and a personal handyphone system (PHS).
